(19) United States
(12) Patent Application Publication
(10) Pub. No.: US 2005/0074548 A1
(43) Pub. Date: Apr. 7, 2005

(54) Method and apparatus for encapsulating electric motors used in washdown, food processing, and chemical applications

(76) Inventors: David K. Puterbaugh, Geneva, IN (US); Claire T. McMillan, Warren, IN (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/678,928

(22) Filed: Oct. 3, 2003

(51) Int. Cl. B05D 5/12; B05D 3/02

(52) U.S. Cl. 427/104; 427/116; 427/384

(57) ABSTRACT

An electric motor includes a motor casing, a stator assembly having wire windings, a shaft, and a rotor. A resin in liquid form is added in a vacuum chamber to the motor casing to surround the wire windings. The resin is added after a number of potting fixtures that restrict the coverage of the resin to the stator assembly are assembled onto the motor casing. The resin cures to form a solid coating encapsulating the wire windings to protect the stator assembly from moisture and contaminants.

### FIELD OF THE INVENTION

The present invention relates generally to processes for extending the working life of electric motors, in particular motors used in applications where they are exposed to high levels of moisture, steam, acidic and/or caustic solutions. More particularly, the present invention describes methods for encapsulating the stator windings of electric motors to counter the effects of oxidative atmospheres. The invention also describes apparatus which can be employed in the encapsulating process.

### BACKGROUND OF THE INVENTION

Commercial food processing facilities and the food products moving through such facilities must be maintained in a scrupulously clean condition. One method of achieving this high level of cleanliness is by means of high-pressure, hose-down cleaning with steam, hot water and/or chemical solutions. During the course of the cleaning operation, electric motors utilized in the manufacturing process are exposed to harsh, oxidative conditions. These “washdown motors” as they are referred to in the trade are also used in chemical manufacturing facilities and the like.

In the course of the cleaning process, the level of humidity in the facility being cleaned increases and corrosive chemicals can become dissolved in the wastewater. Steps can be taken to limit direct contact between the wastewater and the motor itself by locating the motor on a pedestal or other raised area. Nonetheless, the resultant high humidity, particularly in combination with dissolved chemicals in the atmosphere, produces a highly corrosive environment. While precautions can be taken to lessen the ingress of moisture into the motor interior by employing multiple seals and water-tight fittings, some amount of corrosive solution will inevitably enter into the motor interior—around the shaft or through inlets for electrical wiring, resulting in chemical attack on the motor winding.

One other factor that complicates the design of a corrosion-proof motor is heat. Although copper is a very good conductor of electricity, it is subject to I²R losses in the form of heat. In order for an electric motor to operate effectively, this heat build-up must be dissipated, typically through the motor's outer shell or casing.

This combination of steam, heat, moisture and other corrosive factors typically results in very short life cycles for washdown motors. It is not uncommon for such motors to fail within a matter of a few months; in some applications failure occurs in a matter of days or weeks. Motor failure is generally due to bearing problems or chemical attack on the copper winding of the electric motor—in particular, the fixed (or stator) motor windings. This need to constantly replace washdown motors is an added expense to food processors and other users of such motors. Additionally, the need to suspend operations while repairs are made is disruptive to the flow of product through the processing facility and results in increased labor costs.

Thus, there is the need for an electric motor which can be used in washdown applications and which exhibits increased resistance to oxidative attack.

### BRIEF SUMMARY OF THE INVENTION

The present invention discloses a process for manufacturing a corrosion-resistant electric motor which can be employed in applications involving high humidity or other corrosive situations. The motor is particularly useful in washdown applications—i.e., in situations involving the cleaning of motor-powered pumps, conveyors or other equipment used in chemical and food manufacturing facilities.

The method involves the steps of forming an integral, protective coating around the motor's stator. The coating material, when cured, should fill as much of the motor interior as possible. The cured coating should be substantially free of voids or other gaps which could form wells for entraining corrosive liquids within the motor interior. The coating should also have good heat transfer properties so that heat generated while the motor is operating can be transferred to the motor exterior.

The structural components used in the method of the present invention are substantially the same as those used to manufacture conventional electric motors: 1) a generally cylindrical motor casing or shell; 2) a stator assembly fixedly mounted within the motor casing; 3) a rotor shaft assembly comprising a rotor mounted to a shaft, said shaft disposed along the central axis of the motor, with at least one end of the shaft extending outside of the motor casing for coupling to an exterior device (e.g. a pump); 4) bearing assemblies along the shaft for accommodating rotation of the shaft; 5) end caps or bells at each end of the cylindrical motor assembly; and, 6) an electrical inlet in the motor casing for supplying power to the motor. What is different about the process of the present invention is a series of steps in the motor manufacturing process which are designed to protect the motor's stator windings from corrosive attack by liquids or gases.

The motor casing employed in the present invention is preferably manufactured from a corrosion-resistant material such as stainless steel. The open ends of the motor casing can be flared (i.e., have a somewhat larger diameter when compared to the main body of the motor casing) to prevent moisture build-up by facilitating drainage.

The stator assembly of an electric motor is typically a generally cylindrical structure having an outside diameter slightly larger than that of the motor casing main body, thus allowing the stator assembly to fit snugly within the motor casing. Such cylindrical stator assemblies have open internal regions or bores with internal diameters large enough to accommodate the motors rotor and shaft. These stator assemblies include a core which is composed of a plurality of substantially identical circular laminations, each of which has a plurality of inwardly-extending teeth. To form the core, the circular laminations are aligned and arranged in a stack. The teeth of the laminations form a plurality of aligned slots for receiving coils of wire. When the laminations are properly aligned, the core also provides a plurality of bolt holes (generally four) for passage of bolts used to secure casing end bells to each end of the motor. The core laminations are normally formed from a ferrous material such as cold-rolled steel.

A plurality of coils formed from insulated conductive wire (normally copper wire) are inserted into selected core slots with portions of the coils at the ends of the core forming end turn regions. The coils are interconnected to form coil groups or poles. Although the conductive (magnet) wires which form the coils (generally referred to as stator windings) have a thin, insulating coating, this thin coating can easily fail when exposed to high humidity, resulting in electrical short circuits and burn out of the motor.

In a preferred method of the present invention, the stator assembly is given an initial pre-treatment with a varnish or an enamel so that a tough protective coating is formed around the coils. This coating provides protection from high humidity and corrosive chemicals and helps to bond the individual wires together. Specialty varnishes suitable for forming insulating coatings on magnet wire are sold by the John C. Dolph Company of Monmouth Junction, N.J.

A procedure for applying an epoxy varnish (Dolphon CC-1141) is as follows:
1. preheating the stator assembly to a temperature of about 300° F.;
2. placing the heated stator assembly in a vacuum chamber containing a container of liquid varnish;
3(a). i) submerging the stator assembly into the varnish, and ii) pulling a vacuum; or
3(b). i) pulling a vacuum, and ii) submerging the motor assembly into the liquid varnish;
4. maintaining the submerged stator assembly under vacuum for about 20 mm;
5. removing the vacuum and maintaining the stator assembly under pressure (80 PSI) for 20 min;
6. removing the treated stator from the varnish bath and allowing it to drain (The preheating of the stator allows a very thin layer to gel); and
7. placing the drained stator in an oven at a temperature in the range of about 150° to 175° C. for one to five hours.

While this pre-treatment procedure with an epoxy varnish or a similar insulating coating material has been found to improve the working life of the potted washdown motors of the present invention when compared with motors which have been subjected to a potting step, alone, this pre-treatment step can be dispensed with if desired.

After the stator has been formed, an initial step in the method of the present invention is to insert the wound stator assembly into its normal position in the motor casing so that it can be potted in situ. In order to preserve the continuity of the aforementioned bolt holes which extend through the stator core, pins are inserted through the bolt holes to prevent the ingress of potting material into these regions of the stator assembly. The potting process is preferably performed with the electrical conduit box pre-mounted to the outside of the motor casing, and the stator electrical leads extending through holes in the motor casing into the conduit box. This procedure allows the potting material to migrate into any gaps or voids between the bolts which mount the conduit box to the motor casing and the casing wall, and to flow into those regions where the stator electrical leads exit the motor casing into the conduit box.

The potting material employed in the process is preferably a liquid material which will cure to form a solid which is impervious to both liquids and vapor. Because the stator assembly tends to heat up while the motor is running, the cured potting material must have good thermal conductivity to prevent excessive heat-buildup. Stated otherwise, the potting material must have the ability to transfer heat from the cold-rolled-steel stator core to the stainless steel motor casing so that it can be dissipated into the atmosphere. In the preferred embodiment, a two part epoxy system distributed by the Loctite Corporation under the trade names Loctite® Hysol® 3142 (epoxy resin) and 3165 (hardener) is used for a potting material. This two-part resin system has a work time of more than one hour, and a gel time (at 25° C.) of approximately 2.5 hours. When completely cured, the resin has a Shore D hardness of 90 and a thermal conductivity (ASTM F-433) of 0.491 Watts/meter° C.

The above-mentioned Loctite® resin system incorporates a filler to improve the thermal conductivity of the cured material. One of ordinary skill in the art will appreciate that the presence of a filler in the resin is important in order to ensure good heat transfer. Work with clear resin systems suggests that the use of a filler, in particular an alumina filler, in the range of at least 50% by weight, preferably between about 60 and 80% by weight, greatly improves thermal conductivity.

Another preferred potting material is a two-part epoxy resin system manufactured by Cytec Industries, Inc., Olean, N.Y.: Conathane DP-26985 (resin) and DPFR-26985 (hardener).

Before introducing the liquid potting material into the stator-containing motor casing, steps must be taken to ensure that the potting material does not migrate into other areas of the motor, but remains concentrated around the stator assembly. This is accomplished by using a system of potting fixtures or forms comprising: a bottom fixture adapted to close off one end of the motor shell; a longitudinally-extending, tube-like cylindrical form adapted to snugly fit through the stator core; and a top fixture or masking form adapted to close off the other end of the motor shell. This combination of fixtures keeps the potting material out of the bore of the stator core and out of those regions of the motor casing where casing ends (end bells) will be mounted during final motor assembly. The above-described pins which extend through the bolt holes in the stator assembly serve a similar function in preventing occlusion of the bolt holes with potting resin.

The absolute size of the potting fixtures will vary, depending on the size of the electric motor. The potting fixture which is adapted to extend longitudinally through the motor casing should have an outside diameter slightly smaller than the diameter of the stator assembly bore. Similarly, the diameter of the top and bottom fixtures will vary with the geometry of the motor casing in which they are designed to fit. As a general rule, the larger the motor, the larger the diameter of the fixtures used with the motor.

The potting fixtures can be fashioned out of any material having a smooth surface to which the cured potting material will not adhere. For example, a system of polished metal forms having dimensions corresponding to the motor ends and the stator bore could be used. However, the cured (potted) resin tends to expand during motor operation. In order to ensure that the diameter of the stator bore remains sufficiently large enough to accommodate the motor's rotor and shaft, an expandable material is used for the cylindrical boot. Tubular boots formed from a cured silicone elastomer are especially preferred. After insertion of the boot through the stator core, and when it is brought into physical contact with the bottom fixture, the boot can be expanded outwardly by means of a slotted expansion arbor and a tapered expander wedge. These compressive forces force the boot into the stator slot to counter the tendency of the cured potting material to expand during motor operation. The boot expands into the stator teeth keeping potting material away from the area where the rotor shaft will be inserted.

The expansion arbor can be manufactured of a material, which has sufficient rigidity to bear against the elastic or pliable boot and hold it firmly in place when expanded into a second position, yet sufficient elasticity to return to a normally-unexpanded, first condition when the expander wedge is removed. The expander wedge is preferably a conical metal structure which has sufficient mass to both open the expansion arbor and to hold it firmly in place while the liquid resin is introduced and subsequently cured.

Because flexible materials can provide a stoppering effect, bottom and top fixtures, respectively, manufactured of materials such as silicone elastomers are preferred for these structures, also. The bottom fixture is preferably equipped with a mating surface comprising either an upwardly-extending vertical flange or a circular recess corresponding to the boot's diameter. When the bottom fixture mating surface is joined to the bottom end of the boot, liquid potting material is held in the desired location—around the surfaces of the stator assembly and against the adjacent inner wall of the motor casing. In other words, the combination of the circular bottom of the boot with the corresponding raised or lowered region on the bottom fixture forms a seal which prevents liquid resin from flowing around this juncture. Finally, application of a mold release material to the potting fixtures will facilitate their removal after curing.

With the potting fixtures in place, the liquid potting material is ready for introduction into the motor shell. In order to avoid premature gelling, the potting solution should be freshly prepared by mixing the active components shortly before potting. It is generally preferred to de-gas the freshly-prepared liquid material by drawing it into a vacuum pot over a series of discs which serve to thin the material and allow any entrained air to be removed quickly. After the material has been de-aired, the vacuum is released and the liquid potting material is ready to be poured into the motor casing.

In a further effort to avoid the introduction of air into the system, the potting material is preferably introduced while the motor shell and stator are under a negative pressure. This is accomplished by locating the motor shell and potting fixtures in a vacuum chamber and activating a vacuum pump. Removal of air from the casing causes the potting material to flow around the stator assembly without the risk of trapping displaced air in the viscous liquid. The vacuum also improves the seal between the bottom potting fixture and the motor casing.

If possible, the motor shell should be pre-heated prior to placing it in the vacuum chamber. Heating drives off any moisture from humidity and causes the casing and stator assembly to expand; as the components gradually cool in the vacuum chamber, the liquid potting material is drawn into all crevices.

Once the assembly has been de-aired in the vacuum chamber, the liquid potting material is added while the system remains under negative pressure until all open areas of the stator assembly have been filled with liquid material. The amount of potting material will vary with the size of the motor. As a rule of thumb, as much as possible of the motor shell void volume should be filled, recognizing that space must be left for operation of the rotor assembly and its associated hardware (e.g., bearing assemblies and the like). After addition of the liquid potting material, the system is maintained under vacuum for a period of time (e.g., one minute). After releasing the vacuum the level of the material drops because atmospheric pressure bears against the material and then a post vacuum process is performed to pull out any air which could have been trapped in the initial process. After this second vacuum treatment, the vacuum is released and the resin is allowed to cure. In the case of the above-described Loctite® Hysol® 3142/3165 system, cure conditions involve maintaining the resin at about 25° C. for a period of about 24 hours, followed by a bake cycle of 93° C. for a period of about four hours. Alternatively, the resin can be cured in a shorter period of time by using a higher initial cure temperature—four hours at 66°, followed by a bake cycle of four hours at 93° C.

In a preferred procedure, a quantity of liquid potting resin is also added to the conduit box while the assembly is under vacuum. In performing this step, care should be taken to allow the end portions of the stator leads in the conduit box to extend above the surface of the potting material. Moreover, in order to prevent contaminants from leaching into the motor interior, a portion of the lead insulation on the wires can be stripped back so that the wire insulation does not extend above the liquid resin. The cured resin forms a water block around the wire itself, lessening the chance of moisture entering into the motor interior through or around the lead insulation material.

Once the potting material has cured, the fixtures or forms are removed from the motor casing, and the remaining motor components (e.g., shaft, rotor, and casing ends) are introduced into the motor casing in a conventional motor-assembly procedure.

Other features and advantages will become apparent to those in the motor-manufacturing field from the following description of a preferred embodiment of the present invention in combination with the accompanying drawings.

### BRIEF DESCRIPTION OF THE DRAWINGS

FIG. 1 is an exploded view of a motor shell and stator assembly and the fixtures used to hold the liquid encapsulent during the stator-potting process;

FIG. 2 is a partial sectional view showing the location of the bottom potting fixture, stator assembly and a set of guide pins in the motor casing prior to the potting process;

FIG. 3 shows a step subsequent to that of FIG. 2—the introduction of the cylindrical boot and expanding arbor into the motor casing;

FIG. 4 the next step of the potting process—the introduction of the expander wedge into the motor casing;

FIG. 5 illustrates all of the elements of FIG. 1 in place with a potting material in place;

FIG. 6 shows the apparatus of FIG. 5 within a vacuum chamber;

FIG. 7 is a sectional view of an electric motor having its stator elements encapsulated with a protective material;

FIG. 8 is a top elevational view of the outer shell of an electric motor of the present invention with a conduit box mounted to the exterior of the motor casing; and

FIG. 9 is an isometric view of the electric motor of FIG. 8.

### DETAILED DESCRIPTION OF A PREFERRED EMBODIMENT

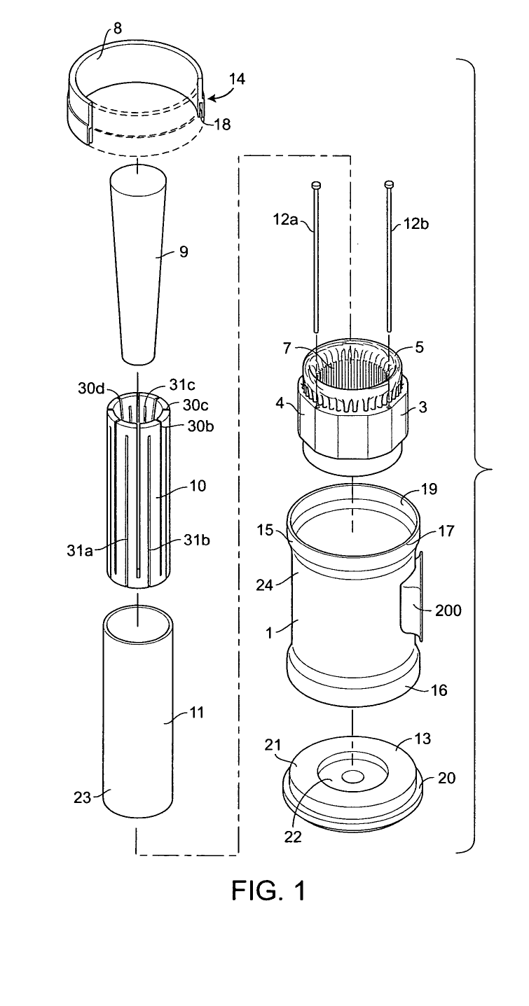

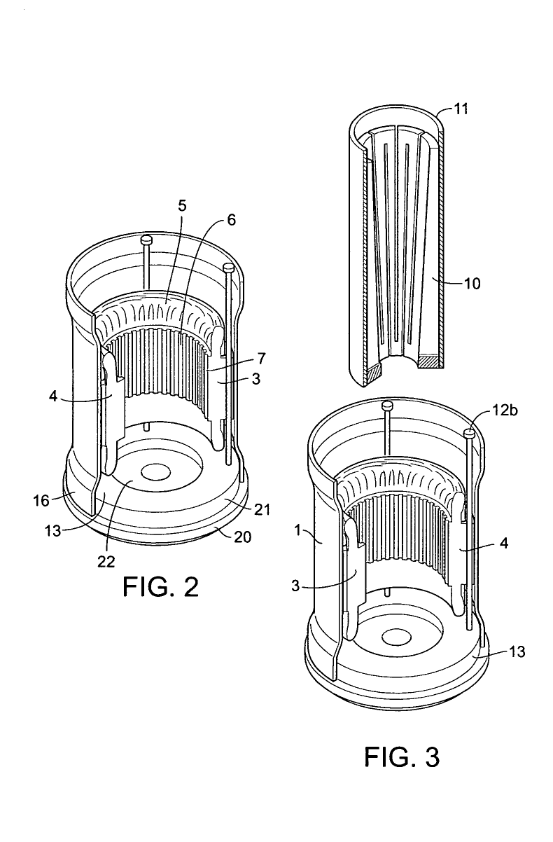

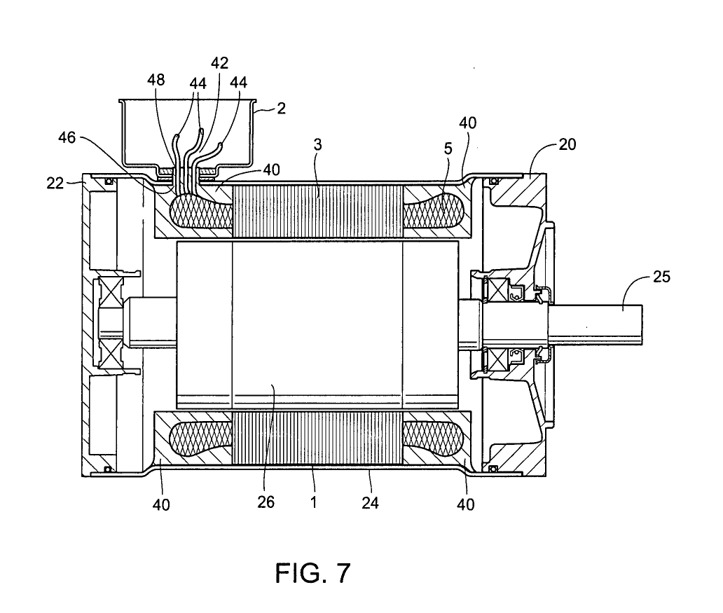

FIG. 1 depicts a motor casing 1 having a cylindrical casing main body 24, flared first and second casing end portions 15, 16, and a motor base 200 mounted to the casing outer surface. A stator assembly 3, whose outside diameter is slightly larger than the inside diameter of casing main body 24, is adapted to be press fitted within the interior of casing 1. (FIG. 2). Stator assembly 3 has a core 4 and wire windings 5 extending through slots 6 of core 4. Stator assembly 3 is generally cylindrical in shape, defining an open internal region or bore 7 for receiving rotor shaft assembly that includes a shaft 25 and rotor 26 (FIG. 7). An electric motor having the foregoing components and constructed with the method described herein is disclosed in application Ser. No. ______, filed contemporaneously herewith, the contents of which is incorporated by reference herein.

In addition to casing 1 and stator assembly 3, FIG. 1 depicts the several forms or fixtures used for the potting process: a top masking fixture 8; an expander wedge 9; an expanding arbor 10; a boot 11; a set (4) in total of pins such as 12a, 12b which are employed to block bolt holes (not shown) in stator assembly 3; and a bottom potting fixture 13 which is adapted to be inserted within a second end portion 16 of motor casing 1. Top masking fixture 8 has an arcuate outer shoulder portion 14 which is dimensioned to fit around the outer surface 17 of flared first casing end 15, and an inner shoulder portion 18 which is adapted to fit within an inner surface 19 of first casing end 15.

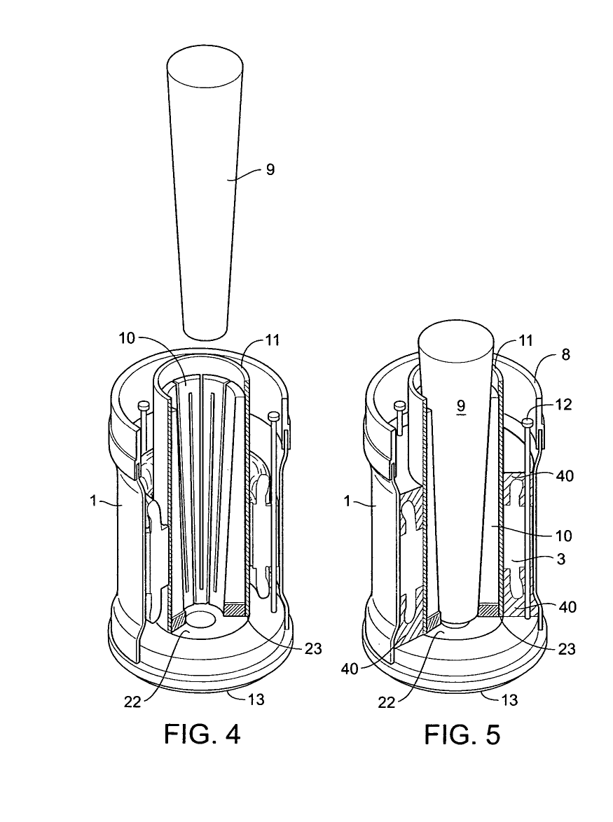

Turning now to FIG. 2, bottom fixture 13 is dimensioned to fit bottom casing end 16, and includes a lower flange portion 20, and a smaller-diameter, vertically-extending collar portion 21 which is adapted to extend into flared casing end 16. A circular recess 22 in bottom fixture collar portion 21 is adapted to receive a bottom end portion 23 of boot 11 (FIG. 4). When mounted in the position shown in FIG. 5, bottom fixture 13 and boot 11 cooperate to keep liquid resin from entering into bottom casing end 16 (FIG. 1).

Referring to FIGS. 1 & 5, expander wedge 9 is a tapered metal structure. Expanding arbor 10 has a series of upwardly extending slots 30a, 30b, 30c and a series of downwardly extending slots 31a, 31b, 31c which allow arbor 10 to expand when wedge 9 is inserted therein. When expanded, arbor 10 exerts outward pressure against boot 11, urging it against stator assembly 3.

FIGS. 1 through 5 depict a series of steps for mounting fixtures 8, 9, 10, 11, 12 & 13 within motor shell 1 and stator assembly 3 prior to performing a potting operation. Top masking fixture 8 could be dispensed with, if desired. However, a liquid potting material 40 (FIG. 5), which is also referred to herein as the liquid resin 40, should not be added until at least bottom potting fixtures 9, 10, 11, 12 and boot 13 are in place within motor casing 1.

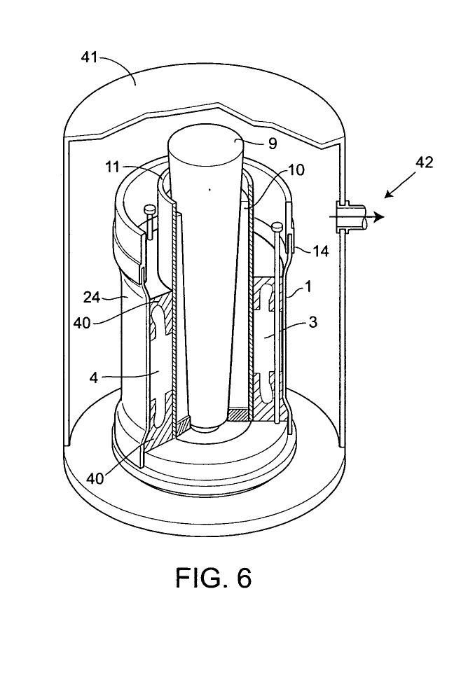

As noted above, FIG. 5 shows liquid potting material 40 surrounding the top and bottom portions of stator assembly 3, but restrained from entry into other areas of the motor by fixtures 8, 11, 12 and 13. Boot 11, in turn, is pressed outwardly toward potting material 40 by the interaction of arbor 10 and wedge 9. Ideally, the addition of potting material 40 takes place after the apparatus has been de-gassed in a vacuum chamber 41 (FIG. 6) which has an air outlet 42 for connection to a vacuum pump (not shown). Removal of air from motor casing 1 and stator assembly 3 prior to the addition of potting material 40 lessens the chance that air will be entrained in the potting material 40, as well as lessening the chance that gaps or voids will be formed between the components of stator assembly 3 and potting material 40 after curing. Ideally, potting material 40 should be added under vacuum.

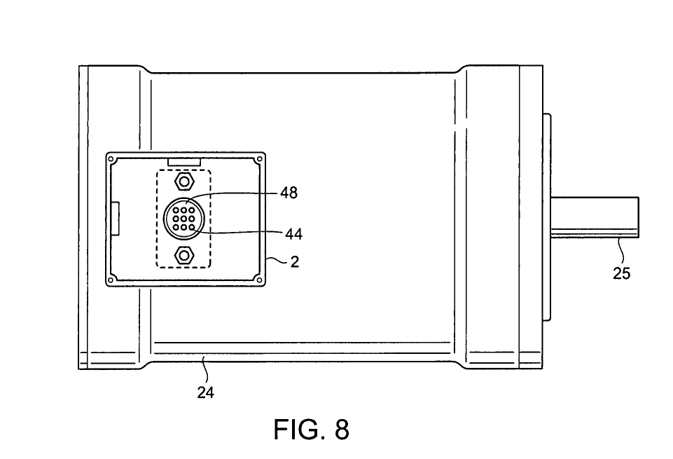

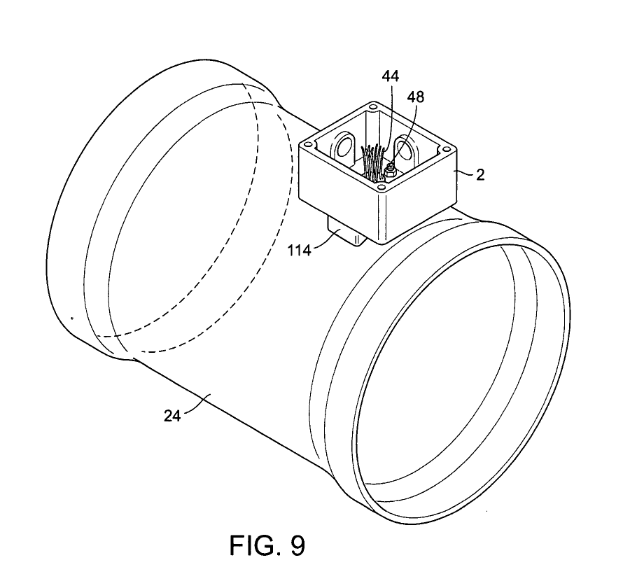

Referring to FIGS. 7-9, a conduit box 2 is shown mounted on the casing main body 24. A wire passageway 42 between the conduit box 2 and the casing main body 24 provides access to stator leads 44 that supply power to the stator assembly 3. Accordingly, the passageway 42 is bound by a casing inlet 46 on the casing main body 24 and a conduit inlet 48 on the conduit box 2. One of ordinary skill in the art will readily recognize that the stator leads 44 are electrical wires that provide power from outside the casing main body 24 to the stator assembly 3.

To provide sealing of the passageway 42 from any moisture and corrosive material that may be present outside the casing main body 24, a quantity of liquid resin 40 is also added to the conduit box 2 while the assembly is under vacuum. The liquid resin 40 seeps into the passageway 42 and seals the bottom of the conduit box 2. In effect, the liquid resin 40 becomes an extension of the liquid resin 40 that covers the wire windings 5. Additionally, to prevent moisture and contaminants from seeping into the casing main body 24 and coming into contact with the stator assembly 3 through the wires, lead insulation of the wires can be stripped back to a level below the level of the liquid resin 40 in the conduit box 2 so that the wire insulation does not extend above the liquid resin 40. Accordingly, moisture and contaminants cannot seep into the casing main body 24 through the wires. Furthermore, because the entire passageway 42 will be sealed with the liquid resin 40, moisture and contaminants cannot enter the casing main body 24 from the area on the casing main body 24 where the conduit box 2 is mounted thereto.

One of ordinary skill in the art will appreciate that the disclosed method forms an integral, protective coating 40 around the motor's stator assembly 3. The coating 40 is substantially free of voids or other gaps so as to prevent formation of wells for entraining corrosive liquids within the motor interior. The coating 40 also provides heat transfer properties so that heat generated while the motor is operating can be transferred to the motor exterior.

In the preferred method of present disclosure, prior to coating the coils of the stator assembly 3 with the liquid resin 40, the stator assembly 3 is given an initial pre-treatment with a varnish or an enamel so that a tough protective coating is formed around the coils. This coating provides protection from moisture and helps to bond the individual wires together. Specialty varnishes suitable for forming insulating coatings are sold by the John C. Dolph Company of Monmouth Junction, N.J.

A procedure for applying an epoxy varnish (Dolphon CC-1141) includes preheating the stator assembly 3 to about 300° F.; placing the heated stator assembly 3 in a vacuum chamber containing a container of liquid varnish; pulling a vacuum and then submerging the stator assembly 3 into the varnish; maintaining the submerged stator assembly 3 in a vacuum for 20 min; removing the vacuum and maintaining the stator assembly 3 under pressure (appox. 80 PSI) for 20 min; removing the treated stator assembly 3 from the varnish bath and allowing it to drain (The preheating of the stator assembly 3 allows a very thin layer to gel); and, placing the drained stator assembly 3 in an oven at a temperature in the range of about 150° to 175° C. for one to five hours.

Although the above described pre-treatment procedure has been found to improve the working life of the potted washdown motors of the present invention when compared with motors which have been subjected to a potting step, alone, this pre-treatment step can be dispensed with if desired.

The potting material 40 employed in the disclosed method is preferably a liquid material which will cure to form a solid which is impervious to both liquids and vapor. Because the stator assembly 3 generates heat during operation, the potting material 40 must have the ability to transfer heat from the cold-rolled-steel stator core 4 and copper windings to the stainless steel motor casing 24 so that it can be dissipated into the atmosphere. Accordingly, one of ordinary skill in the art will appreciate that the cured potting material 40 must have good thermal conductivity to prevent excessive heat-buildup. In a preferred embodiment, a two part epoxy system distributed by the Loctite Corporation under the trade names Loctite® Hysol® 3142 (epoxy resin) and 3165 (hardener) is used for a potting material 40. This two-part resin system has a work time of more than one hour, and a gel time (at 25° C.) of approximately 2.5 hours. When completely cured, the resin has a Shore D hardness of 90 and a thermal conductivity (ASTM F-433) of 0.491 Watts/meter° C.

The above-mentioned Loctite® resin system incorporates a filler to improve the thermal conductivity of the cured material. One of ordinary skill in the art will appreciate that the presence of a filler in the resin is important in order to ensure good heat transfer. Work with clear resin systems suggests that the use of a filler, in particular an alumina filler, in the range of at least 50% by weight, preferably between about 60 and 80% by weight, greatly improves thermal conductivity.

The potting fixtures 8-11, 13, 12a and 12b (FIG. 1) can be fashioned out of any material having a smooth surface which will not adhere to the cured potting material 40. For example, a system of polished metal forms having dimensions corresponding to the motor ends 15 and 16, and the stator bore 7 could be used. However, the cured potting resin 40 tends to expand during motor operation. In order to ensure that the diameter of the stator bore 7 diameter remains sufficiently large enough to accommodate the rotor 26 and shaft 25, an expandable material is used for the cylindrical boot 11. Tubular boots formed from a pliable elastomer are especially preferred.

After insertion of the boot 11 through the stator assembly 3, and when it is brought into physical contact with the bottom fixture 13, the boot 11 can be expanded outwardly by the expansion arbor 10 and the expander wedge 9. These compressive forces force the boot 11 into the stator bore 7 and forming into each slot to counter the tendency of the potting material 40 to expand. The expansion arbor 10 can be manufactured of a material, such as an epoxy resin, which has sufficient rigidity to bear against the pliable boot 11 and hold it firmly in place when expanded into a second position, yet sufficient elasticity to return to a normally-unexpanded, first condition when the expander wedge 9 is removed. The expander wedge 9 is preferably a conical metal structure which has sufficient mass to both open the expansion arbor 10 and to hold it firmly in place while the liquid resin 40 is introduced and subsequently cured.

Because flexible materials can provide a stoppering effect, bottom and top fixtures 13 and 8, respectively, manufactured of materials such as pliable elastomers are preferred for these structures. The bottom fixture 13 is preferably equipped with a mating surface comprising either an upwardly-extending vertical flange or a circular recess corresponding to the boot's diameter. When the bottom fixture 13 mating surface is joined to the bottom end of the boot 11, liquid potting material 40 is held in the desired location—around the surfaces of the stator assembly 3 and against the adjacent inner wall of the motor casing 24. In other words, the combination of the circular bottom of the boot 11 with the corresponding raised or lowered region on the bottom fixture 13 forms a seal which prevents liquid resin 40 from flowing around this juncture. Finally, application of a mold release material to the potting fixtures 8-11, 13, 12a, 12b, 12c and 12d will facilitate their removal after curing.

If possible, the stator assembly 3 should be pre-heated prior to placing it in the vacuum chamber 41. Heating causes the casing 24 and stator assembly 3 to expand; as the components gradually cool in the vacuum chamber 41, the liquid potting material 40 is drawn into any crevices.

Once the assembly has been de-aired in the vacuum chamber 41, the liquid potting material 40 is added while the system remains under negative pressure until all open areas of the stator assembly 3 have been filled with liquid material 40. The system is maintained under vacuum for a period of time (1-3 minutes). The vacuum is then released vacuum is reapplied as a post vacuum for 1-3 minutes and the resin 40 is allowed to cure. In the case of the above-described Loctite® Hysol® 3142/3165 system, cure conditions involve maintaining the resin at about 25° C. for a period of about 24 hours, followed by a bake cycle of 93° C. for a period of about four hours. Alternatively, the resin 40 can be cured in a shorter period of time by using a higher initial cure temperature—four hours at 66°, followed by a bake cycle of four hours at 93° C.

Once the potting material has cured, the fixtures or forms are removed from the motor casing 24, and the remaining motor components (e.g., shaft, rotor, and casing ends) are introduced into the motor casing 24 in a conventional motor-assembly procedure.

The disclosed motor is a corrosion-resistant electric motor which can be employed in applications involving high humidity or other corrosive situations. The motor is particularly useful in washdown applications—i.e., in situations involving the cleaning of motor-powered pumps, conveyors or other equipment used in chemical and food manufacturing facilities. The resin surrounding the wire windings and the epoxy coating of the rotor 26 provide additional protection should moisture, and in particular, highly corrosive material enter into the motor casing.

One of ordinary skill in the art will appreciate that with the disclosed method, there is no need for an inverter duty wire—used in conventional motors to compensate for the presence of oxygen around the stators which can result in corona effects. Because the potting step forms a thick, air-impermeable layer around the stator assembly, a corona resistant wire is not required.

1. A process for encapsulating an electric motor stator assembly with a protective resin comprising:
providing a stator assembly comprising a metallic core and a plurality of stator windings, said stator core having a central bore for passage of a rotor shaft assembly through said core;
coaxially mounting said stator assembly within a substantially cylindrical motor casing having a pair of open ends;
inserting a flexible bottom masking fixture into one end of said motor casing, said bottom masking fixture adapted to extend into said motor casing and to contact said casing to form a liquid-impervious seal;
arranging said motor casing and stator assembly on a substantially horizontal surface so that the axis of said motor casing extends vertically and said bottom masking fixture is located at the base of the casing;
placing a cylindrical boot into said motor casing, through said stator assembly central bore, whereby one end of said boot is in contact with said bottom fixture, said boot having an outside diameter which is greater than the diameter of said rotor shaft assembly;
introducing a curable liquid resin around the stator assembly, into a region defined by the outer surface of said cylindrical boot and the inner surface of the motor casing, until the top portions of the stator assembly are covered with liquid resin, wherein said liquid resin contains filler in an amount of at least fifty percent by weight and wherein said liquid resin in said stator assembly is substantially free of entrained air;
curing said liquid resin to form a moisture-impervious, solid coating between said stator assembly and said motor casing, said solid coating capable of transferring heat from the stator assembly to the motor casing; and
removing said boot and said bottom masking fixture from said motor casing.

2. The method of claim 1 wherein an electrical conduit box is mounted to exterior of said motor casing, a wire passageway between said motor casing and said conduit box, and electrical wires extending into said conduit box from the interior of said motor casing, said method further including the steps:
introducing a quantity of substantially-air-free liquid resin into said conduit box in an amount sufficient to cover the bottom portion of the electrical wires extending into said conduit box; and
curing said liquid resin in said conduit box.

3. The method of claim 2 wherein a bottom portion of an electrical wire extending into said conduit box has an insulating coating thereon, and a top portion of said electrical wire is free from an insulating coating, further including the step:
adding a quantity of liquid resin to said conduit box in an amount sufficient to extend above the insulating coating on said electrical wire.

4. The method of claim 1 wherein said cylindrical boot is formed from a flexible material.

5. The method of claim 4 wherein said flexible material comprises a silicone elastomer.

6. The method of claim 4, further including the steps:
inserting an expandable arbor into said flexible boot; and
expanding said arbor whereby said flexible boot is urged outwardly against an inner surface of said stator assembly.

7. The method of claim 6 further including the steps:
providing an expander wedge for insertion into said expandable arbor; and
inserting said wedge into said arbor.

8. The method of claim 7 wherein said wedge comprises a conical metal structure.

9. The method of claim 1 wherein said stator assembly is pre-treated with an insulating varnish prior to insertion into said motor casing, said pre-treating steps comprising:
a. preheating the stator assembly to a temperature in excess of 100° C.;
b. submerging the stator assembly into a liquid varnish;
c. drawing a vacuum in and around the stator assembly;
d. maintaining the stator assembly under vacuum for a period of time;
e. removing the vacuum and maintaining the stator assembly under pressure for a period of time;
f. removing the stator assembly from the liquid varnish and allowing it to drain; and
g. heating the stator assembly for a period sufficient to form a cured, electrically-insulating coating on the exterior surfaces of said stator assembly.

10. The method of claim 9 wherein said varnish comprises an epoxy resin.

11. The method of claim 1 wherein said curable liquid resin is subjected to an air-removal process prior to its introduction around said stator assembly.

12. The method of claim 11 further including the steps:
placing the motor casing within a vacuum chamber after the insertion of said bottom fixture and said cylindrical boot into said casing;
connecting said vacuum chamber to a vacuum pump;
evacuating air from said vacuum chamber; and
maintaining said vacuum chamber under negative pressure during the introduction of liquid resin around said motor stator assembly.

13. The method of claim 1 further including:
providing a top masking fixture at one end of said motor casing; and
removing said top masking fixture after said curing step.

14. The method of claim 13 wherein said top masking fixture, said bottom masking fixture and said boot are treated with a mold release agent prior to insertion into said motor casing.

15. The method of claim 1 wherein said curable liquid resin comprises a two-component epoxy resin.

16. The method of claim 15 wherein the amount of said filler is between 60 to 80% by weight of said resin.

17. The method of claim 15 wherein said filler comprises alumina.

18. The method of claim 1 wherein said stator assembly comprises a plurality of bolt passageways for mounting end bells to said motor casing, further including the steps:
inserting elongated pins into each of said bolt passageways prior to the introduction of liquid resin around the stator assembly; and
removing said elongated pins from the bolt passageways after the resin has cured.

19. Apparatus for the in situ potting of an electric motor stator assembly concentrically mounted in a cylindrical motor casing, said stator assembly having an inner surface defining a central bore for passage of a rotor shaft assembly said potting apparatus comprising:
an elongated, flexible cylindrical boot adapted to fit within said stator assembly central bore, a top end of said cylindrical boot adapted to extend above the top surface of said stator assembly;
a flexible bottom masking fixture having a vertically-extending collar portion adapted to fit within one end of said motor casing, and a mating surface on said collar portion for connecting to a bottom end of said cylindrical boot;
an elongated mandrel adapted in a first position to fit within said cylindrical boot, said mandrel further adapted to expand from said first position to a second position wherein the cylindrical boot is urged outwardly against the inner surface of said stator assembly; and
an expansion wedge insertable into said elongated mandrel for moving the mandrel from the first position to the second position.

20. Apparatus in accordance with claim 19 wherein the inner surface of said stator assembly comprises a plurality of teeth, and the expansion of said elongated mandrel against said cylindrical boot urges said boot into any gaps in said teeth.
